(19) United States
(12) Patent Application Publication
(10) Pub. No.: US 2007/0116007 A1
(43) Pub. Date: May 24, 2007

(54) Method and system for scheduling and resource allocation in a data communication network

(76) Inventors: Weimin Xiao, Hoffman Estates, IL (US); Amitava Ghosh, Buffalo Grove, IL (US); Rapeepat Ratasuk, Hoffman Estates, IL (US)

Correspondence Address: MOTOROLA, INC., 1303 EAST ALGONQUIN ROAD, IL01/3RD, SCHAUMBURG, IL, 60196, US

(21) Appl. No.: 11/282,538

(22) Filed: Nov. 18, 2005

(51) Int. Cl. H04L 12/56; H04J 3/00

(52) U.S. Cl. 370/395.4; 370/345

(57) ABSTRACT

A method for scheduling and resource allocation in a data communication network (104) that transports data packets for a plurality of sessions is disclosed. The method includes monitoring a packet delay of a session data packet awaiting transport (302). The method also includes re-evaluating a scheduling priority of the session data packet (304). The re-evaluation of the scheduling priority is based on one or more functions of the packet delay.

### FIELD OF THE INVENTION

This application is related to U.S. patent application Ser. No. 11/235625, filed on Sep. 26, 2005, entitled “Method To Determine A Scheduling Priority Value For A User Data Connection Based On A Quality Of Service Requirement”, and assigned to the assignee hereof.

### FIELD OF THE INVENTION

The present invention relates in general to data communication networks, and more specifically, to scheduling and resource allocation in a data communication network.

### BACKGOUND

A network includes a plurality of devices. Examples of a network include an Internet, a Code Division Multiple Access (CDMA) network, a Global System for Mobile Communications (GSM) network, and a Local Area Network (LAN). The plurality of devices communicate among themselves. Examples of a device include a mobile phone, a landline telephone, a satellite phone, a computer, a laptop, a PDA, and a combination of two or more devices. The plurality of devices utilize one or more services for the communication. Examples of a service include Voice over Internet Protocol (VoIP), video streaming, audio streaming, text messaging, and multimedia messaging. Information related to the services is exchanged in data packets. A data packet is a unit of information that is transmitted over a network. A server in the network manages and controls the exchange of data packets, associated with the services, among the plurality of devices.

Some of the services can be delay-sensitive services. A delay-sensitive service is a time-critical service, the functioning of which can be affected if there is a delay in the transportation of data packets associated with the service. Examples of delay-sensitive services include VoIP, video streaming, and audio streaming. When two or more devices communicate among themselves, using VoIP, a delay in the delivery of data packets, associated with the VoIP service, can degrade the voice quality, e.g., in the form of disturbance, a lag, an echo, or even complete loss of voice at the destination device.

There are various methods for managing delay in the delivery of data packets associated with delay-sensitive services in the network. One such method includes scheduling the delivery of data packets associated with more delay-sensitive services by increasing their priority relative to data packets associated with less delay-sensitive services. The data packets with a higher priority are transported before those with a lower priority. Another method includes scheduling the delivery of the data packets associated with delay-sensitive services by increasing the priority of data packets having a greater average delay of the data packets relative to other data packets that are delay sensitive.

However, the methods described above have one or more of the following limitations. Firstly, the methods may entail inefficient allocation of the resources of the network while transporting the data packets of the delay-sensitive services, thereby clogging the network, which may result in even more delay. Secondly, the methods do not maintain a satisfactory delay performance for VoIP. Therefore, the voice quality is degraded significantly. Thirdly, the methods are not efficient when delay-sensitive services and other services operate simultaneously in the network. Finally, the methods may not be able to maintain a satisfactory Quality of Service (QoS) of delay requirements.

### BRIEF DESCRIPTION OF THE DRAWINGS

In the accompanying figures, like reference numerals refer to identical or functionally similar elements throughout the separate views. These figures, together with the detailed description below, are incorporated in and form part of the specification, and serve to further illustrate the embodiments and explain various principles and advantages, in accordance with the present invention.

FIG. 1 represents an exemplary environment, where various embodiments of the present invention may be practiced;

FIG. 2 is a block diagram illustrating the interaction between a server and a device, in accordance with an embodiment of the present invention;

FIG. 3 is a flowchart illustrating a method for scheduling and resource allocation in a data communication network, in accordance with an embodiment of the present invention;

FIG. 4 represents a graph illustrating the variation of a delay-sensitive factor, with respect to a packet delay of a session data packet awaiting transport associated with a service, in accordance with an embodiment of the present invention;

FIG. 5 is a flowchart illustrating a method for scheduling and resource allocation in a data communication network, in accordance with another embodiment of the present invention; and

FIG. 6 is a flowchart illustrating a method for calculating a scheduling priority, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to scheduling and resource allocation in a data communication network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The present invention describes a method for scheduling and resource allocation in a data communication network. The method includes monitoring a packet delay of a session data packet and scheduling the session data packet for transport, based on a priority. The priority is calculated, based on the packet delay of the session data packet.

The present invention also describes a system for scheduling and resource allocation in a data communication network. The system includes a tracking module and a packet scheduler. The tracking module monitors a packet delay of a session data packet. The packet scheduler schedules the session data packet for transport based on a priority. The priority is calculated based on the packet delay of the session data packet.

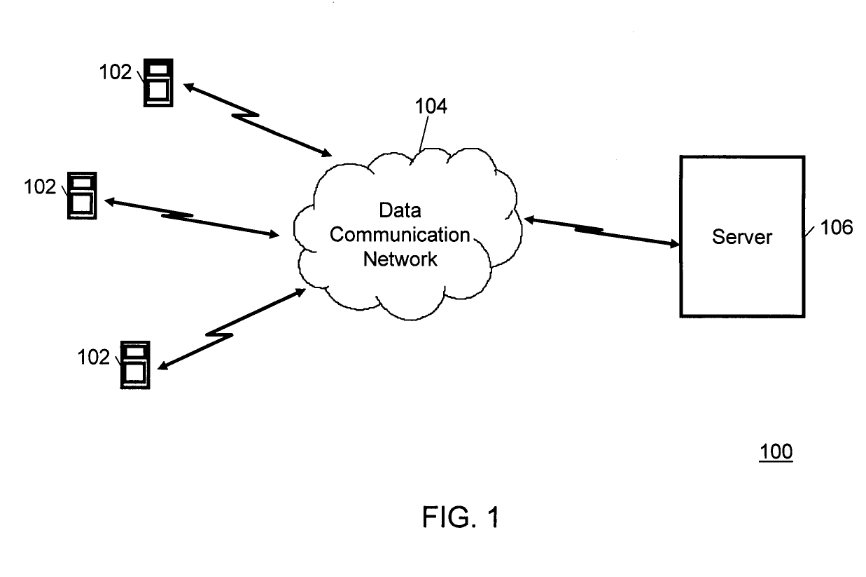

FIG. 1 represents an exemplary environment, wherein various embodiments of the present invention may be practiced. A network 100 includes a plurality of devices 102, a data communication network 104 and a server 106. Devices in the plurality of devices 102 communicate among themselves. Information related to the communication is transported in data packets via the data communication network 104. The data communication network 104 transports session data packets for a plurality of sessions. A session data packet is a data packet corresponding to a session associated with a service. A session is the period during which a particular service exists. Some of the services from the one or more services can include one or more delay-sensitive services. Examples of a delay-sensitive service include Voice over Internet Protocol (VoIP), video streaming, and audio streaming. Examples of a service, other than delay-sensitive services include text messaging service and multimedia messaging service. These session data packets associated with the one or more services await transport at the server 106, which assigns a priority to the session data packets associated with the delay-sensitive services. The server 106 schedules the transport of the session data packets via the data communication network 104. The session data packets with the higher priority are scheduled to transport earlier than the data packets with a lower priority.

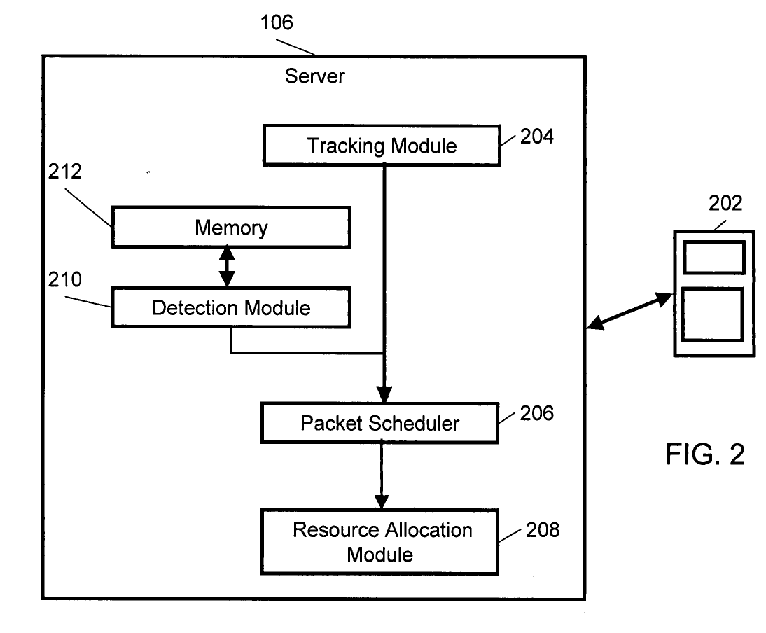

FIG. 2 is a block diagram illustrating the interaction between a server 106 and a device 202 from the plurality of devices 102, in accordance with an embodiment of the present invention. The server 106 includes a tracking module 204, a packet scheduler 206, a resource allocation module 208, a detection module 210, and a memory 212. The server 106 schedules the transport of a session data packet of a session associated with a service. The tracking module 204 monitors a packet delay of the session data packet awaiting transport at the server 106. A packet delay is the duration for which a session data packet awaits transport. The packet scheduler 206 re-evaluates a scheduling priority of the session data packet, based on one or more functions of the packet delay. In an embodiment of the present invention, the packet scheduler 206 increases the scheduling priority of the session data packet when the packet delay becomes more than a threshold value.

In an embodiment of the present invention, the resource allocation module 208 allocates network resources for transporting data packets for a plurality of sessions. A network resource is a component of the network that can be dedicated to a particular program or process. Examples of a network resource include the available bandwidth, memory, and so forth. When a session data packet with a high priority is transported, more network resources are required for its transportation. In an embodiment of the present invention, the detection module 210 identifies a service associated with a session data packet. A Quality of Service (QoS) is maintained for the one or more services. QoS refers to various schemes to ensure a particular level of quality, i.e., keeping the delay of the data packets of a service below a limit specified in the QoS for the service. For example, the QoS for a service can define a limit for the amount of delay in session data packets associated with the service, i.e., the packet delay for the service should not exceed the defined limit. The memory 212 stores one or more QoS for the one or more services. Based on the QoS for a service, the packet scheduler 206 re-evaluates a scheduling priority of a session data packet associated with the service, based on the QoS for a service.

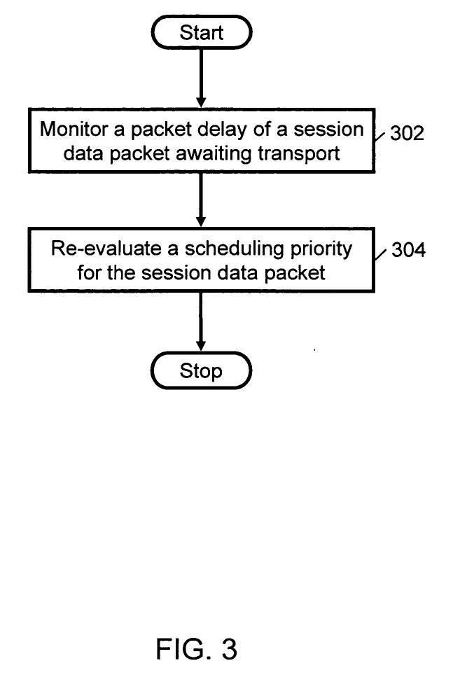

FIG. 3 is a flowchart illustrating a method for scheduling and resource allocation in a data communication network 104, in accordance with an embodiment of the present invention. At step 302, a packet delay of a session data packet awaiting transport is monitored. The tracking module 204, at the server 106, monitors the packet delay of the session data packet. At step 304, a scheduling priority of the session data packet is re-evaluated. The re-evaluation of the scheduling priority is based on one or more functions of the packet delay of the session data packet. The packet scheduler 206 re-evaluates the scheduling priority of the session data packet.

In an embodiment of the present invention, the re-evaluation of the scheduling priority is based on a three-stage function of the packet delay. The three-stage function, which is a non-decreasing function, is such that the value of the three-stage function increases as the packet delay of the session data packet increases. The increase in the value of the three-stage function is slow as long as the packet delay is less than a first value of the packet delay. This is followed by a rapid increase till the packet delay is less than a second value of the packet delay. Thereafter the rise in the packet delay stagnates. The re-evaluation of the scheduling priority is also based on a current value of a session priority of the session data packet. A priority assigned to data packets associated with a session is called a session priority. The session priority is based on factors other than packet delays of the session data packets. These factors include a channel quality metric (CQM) associated with a session during which the session data packet is transported. CQM is a measure of quality of a channel in a network. The quality of the channel includes its error rate, signal strength, and so forth. Examples of CQM include the bit error rate estimate, the received signal strength, and the carrier-to-interference ratio (C/I).

In another embodiment of the present invention, network resources are allocated for the transportation of data packets for the plurality of sessions. This allocation is based on the re-evaluation of the scheduling priority, which varies with the variation in a delay-sensitive factor. The resource allocation module 208 allocates network resources for transporting the data packets for the plurality of sessions.

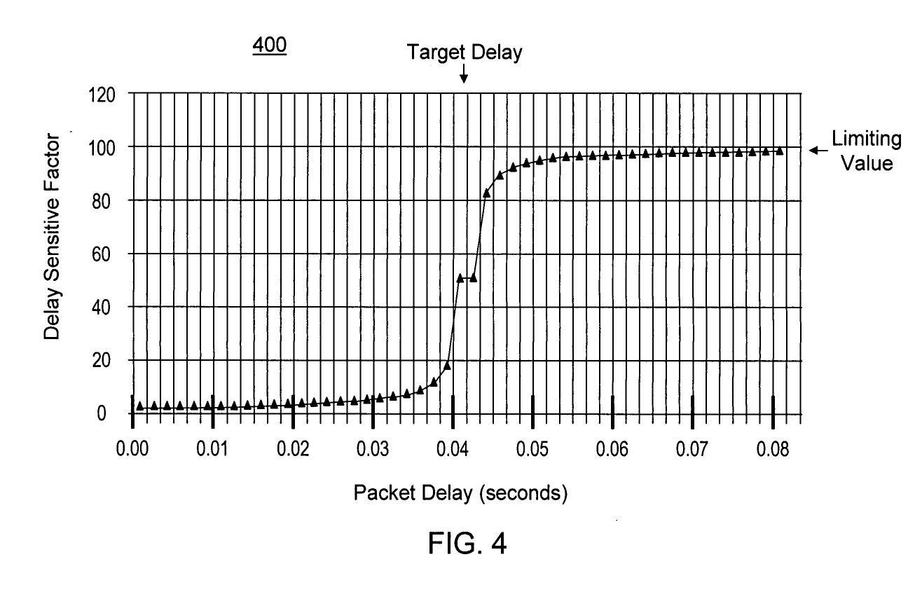

FIG. 4 represents a graph 400 illustrating the variation of a delay-sensitive factor, with respect to a packet delay of a session data packet awaiting transport associated with a service, in accordance with an embodiment of the present invention. In the graph 400, the X-axis represents the packet delay of an ‘n’th session data packet, measured in seconds; and the Y-axis represents the delay-sensitive factor for the ‘n’th session data packet. The delay-sensitive factor varies with the variation in the packet delay of the ‘n’th session data packet.

As shown in the graph 400, the delay-sensitive factor assumes a value that is equal to unity when the ‘n’th session data packet does not experience any packet delay. As the ‘n’th session data packet starts experiencing increased packet delay, the delay-sensitive factor also increases. This increase continues till the packet delay reaches a target delay. The target delay is a value of a packet delay of a session data packet that is configured at the server 106. The target delay for a service can be configured, based on the requirements of the data communication network 104 or (and) on QoS for the service. In an embodiment of the present invention, an exemplary function that can be used to calculate the delay sensitive factor is:

$${F}_{i} [ n ] = \frac{ψ}{ψ - {Γ}_{i} [ n ]} when {Γ}_{i} [ n ] < ψ$$

$${F}_{i} [ n ] = 2 \frac{ψ}{δ} + \frac{ψ}{ψ - {Γ}_{i} [ n ]} when {Γ}_{i} [ n ] \geq ψ$$

where Fᵢ[n]≧1 represents the delay-sensitive factor for ‘n’th session data packet for a user i using the service,

ψ represents the target delay for ‘n’th session data packet for the user i using the service (one example of a value for ψ is 0.040833 seconds),

Γᵢ[n] represents the packet delay for ‘n’th session data packet for the user i using the service, and

δ represents a constant associated with the ‘n’th session data packet for the user i using the service (one exemple of a value for δ is 0.000833 seconds).

When the packet delay experienced by the session data packet is much less then the target delay, then the delay-sensitive factor,

$${F}_{i} [ n ] = \frac{ψ}{ψ - {Γ}_{i} [ n ]} ,$$

increases slowly with the increase in the packet delay. As the experienced packet delay approaches the target delay, the delay-sensitive factor increases rapidly.

When the packet delay experienced by the ‘n’th session data packet is more than the target delay, then the delay-sensitive factor,

$${F}_{i} [ n ] = 2 \frac{ψ}{δ} + \frac{ψ}{ψ - {Γ}_{i} [ n ]} ,$$

keeps increasing rapidly till it approaches a limiting value. The limiting value is selected to ensure that the value of the priority of a session data packet does not rise to infinity. The delay-sensitive factor bears a non-linear relationship with the packet delay. The delay sensitive factor stagnates on approaching the limiting value. It will be appreciated that the equation given above, to calculate the delay-sensitive factor, is representative. Any other equation that displays the required variation can be used with various embodiments of the invention.

A scheduling priority of the ‘n’th session data packet for the user i using the service may be assigned as:

$${P}_{i} [ n ] = \frac{{( {DRR}_{i} [ n ] )}^{α}}{{( {T}_{i} [ n ] )}^{β}} {( {F}_{i} [ n ] )}^{γ}$$

where Pᵢ[n] is a scheduling priority of the ‘n’th session data packet,

$$\frac{{( {DRR}_{i} [ n ] )}^{α}}{{( {T}_{i} [ n ] )}^{β}}$$

represents a session priority of the ‘n’th session data packet for the user i using the service,

DRRᵢ[n] represents a channel quality metric for the ‘n’th session data packet for the user i using the service,

Tᵢ[n] represents a time average throughput for the ‘n’th session data packet for the user i using the service,

Fᵢ[n] represents the delay sensitive factor for the ‘n’th session data packet for the user i using the service, and

α, β, and γ represent constants, to adjust the fairness and relative priority of the ‘n’th session data packet for the user i using the service. Example values of α, β, and γ are 1, 0.75, and 2 respectively.

It should be appreciated that various embodiments of the invention can be practiced with other factors (not just limited to the time average throughput) for calculating the scheduling priority. Two examples of other factors are a Quality of Service factor that encompasses quality measurements other than delay, and traffic type (such as control signaling traffic)

As the channel quality metric and the time average throughput do not depend on the packet delay of the session data packet, the session priority is also independent of the packet delay. The scheduling priority is proportional to the delay-sensitive factor. Therefore, a variation in the delay-sensitive factor causes similar variations in the scheduling priority of the ‘n’th session data packet.

In another embodiment of the present invention, an acrtan function of the form α tan⁻¹(bΓᵢ[n]−c)+d), where a, b, c and d are constants, can be used for computing the delay sensitive factor for a session data packet. Therefore, the delay sensitive factor can be calculated as:
Fᵢ[n]=α tan⁻¹(bΓᵢ[n]−c)+d
where, a, b, c, and d are constants that form the curve with the required variation. Exemplary values for a, b, c and d are 31.2, 500/second, 25 and 49, respectively.

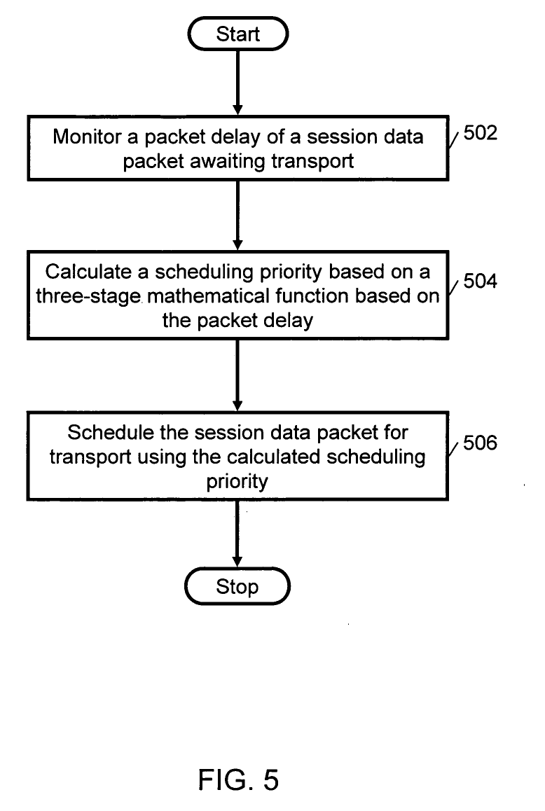

FIG. 5 is a flowchart illustrating a method for scheduling and resource allocation in a data communication network 104, in accordance with another embodiment of the present invention. At step 502, a packet delay of a session data packet awaiting transport, is monitored. At step 504, a scheduling priority is calculated for the session data packet, based on a three-stage mathematical function. The three-stage mathematical function is based on the packet delay of the session data packet. At step 506, the session data packet is scheduled for transport, using the calculated scheduling priority.

In an embodiment of the invention, network resources used to transport the session data packets are allocated, based on the calculated scheduling priority.

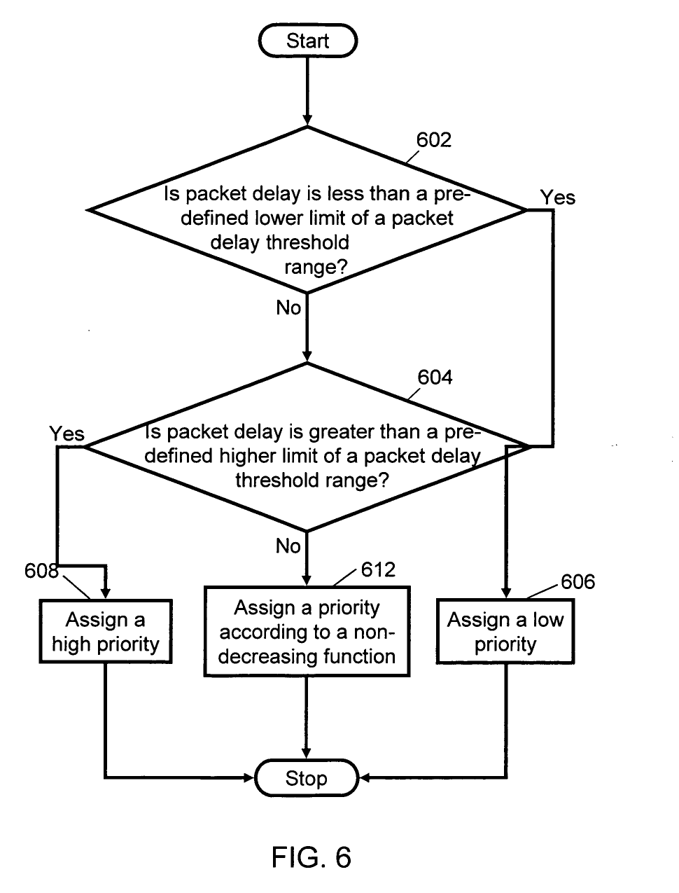

FIG. 6 is a flowchart illustrating a method for calculating a scheduling priority, in accordance with another embodiment of the present invention. At step 602, it is determined whether a packet delay is less than a pre-defined lower limit of a packet delay threshold range. A pre-defined lower limit of the packet delay threshold range is a target delay that can be configured at the server 106. If the packet delay is less than the pre-defined lower limit of the packet delay threshold range, then the step 604 is performed. At step 604, a low priority is assigned to the session data packet. This low priority is approximately equal to a session priority that is calculated for the session data packet without using packet delay. The session priority is based on at least one of a channel quality metric and a time average throughput associated with a session during which the session data packet is transported. The packet scheduler 206 assigns the low priority to the session data packet. If the packet delay is not less than the pre-defined lower limit of the packet delay threshold range, then step 606 is performed. At step 606, it is determined if the packet delay is greater than a pre-defined higher limit of the packet delay threshold range. If the packet delay is greater than the pre-defined higher limit of the packet delay threshold range, then step 608 is performed. At step 608, a high priority is assigned to the session data packet. The high priority is substantially greater than the session priority calculated for the session data packet, without using the packet delay. The high priority is limited to a pre-defined ceiling, which is a maximum scheduling priority that can be assigned to a session data packet. In an embodiment of the present invention, the packet scheduler 206 assigns the high priority to the session data packet. If the packet delay is not greater than the pre-defined higher limit of the packet delay threshold range, then step 610 is performed. At step 610, a priority is assigned to the session data packet data according to a non-decreasing function that varies between the low and high priorities. In an embodiment of the present invention, the packet scheduler 206 assigns the priority to the session data packet.

Various embodiments of the present invention offer the following advantages. The present invention provides a method and system for scheduling and resource allocation in a data communication network. The method and system enable assigning a high priority to a session data packet based on a packet delay experienced by the packet. A higher packet delay assures a higher priority being assigned to the session data packet, but is limited to a maximum value of the priority. Session data packets suffering with a higher packet delay are given high priority. Thereby, the network resources are used efficiently. This ensures that an increased number of session data packets are handled for a given installed capacity of network resources, which translates into increased revenues for service providers. The QoS for one or more services can be maintained, providing a better quality of services.

It will be appreciated the modules described herein may be comprised of one or more conventional processors and unique stored program instructions that control the one or more processors to implement, in conjunction with certain non-processor circuits, some, most, or all of the functions of the modules described herein. The non-processor circuits may include, but are not limited to, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for scheduling and resource allocation in a data communication network that transports data packets for a plurality of sessions, comprising:
monitoring a packet delay of a session data packet awaiting transport; and
reevaluating a scheduling priority for the session data packet, the reevaluation being based on one or more functions of the packet delay.

2. The method of claim 1, wherein the packet delay is a duration for which a session data packet awaits transport.

3. The method of claim 1, wherein one of the one or more functions for reevaluating the scheduling priority are a three-stage function of the packet delay.

4. The method of claim 1 further comprising allocating network resources used to transport the data packets for the plurality of sessions, the allocation being based on the reevaluated scheduling priority.

5. The method according to claim 1, wherein reevaluating the scheduling priority is further based on a current value of a session priority for the session data packet, wherein the session priority is based on factors other than the packet delay.

6. The method according to claim 5, wherein the session priority is based on factors that include a channel quality metric associated with a session during which the session data packet is transported.

7. The method according to claim 5, wherein the scheduling priority is assigned as:
wherein, Pᵢ[n]=sᵢ(n)×(Fᵢ[n])^{Y} wherein,
$${F}_{i} [ n ] = \frac{ψ}{ψ - {T}_{i} [ n ]}$$
when Tᵢ[n]<ψ and
$${F}_{i} [ n ] = 2 \frac{ψ}{δ} + \frac{ψ}{ψ - {T}_{i} [ n ]}$$
when Tᵢ[n]≧ψ
wherein sᵢ(n) denotes the session priority.

8. A method for scheduling and resource allocation in a data communication network that transports data packets for a plurality of sessions, comprising:
monitoring a packet delay of a session data packet awaiting transport;
calculating a scheduling priority based on a three-stage mathematical function based on the packet delay; and
scheduling the session data packet for transport using the calculated scheduling priority.

9. The method according to claim 8, wherein calculating the scheduling priority based on the three-stage mathematical function comprises assigning a low priority to the session data packet when the packet delay is less than a pre-defined lower limit of a packet delay threshold range.

10. The method according to claim 9, wherein the low priority is approximately equal to a session priority calculated for the session data packet without using the packet delay.

11. The method according to claim 10, wherein the session priority is based on factors that include at least one of a channel quality metric and a time average throughput associated with a session during which the session data packet is transported.

12. The method according to claim 8, wherein calculating the scheduling priority based on the three-stage mathematical function comprises assigning a high priority to the session data packet when the packet delay is more than a pre-defined higher limit of a packet delay threshold range.

13. The method according to claim 12, wherein the high priority is substantially greater than a session priority calculated for the session data packet without using the packet delay.

14. The method according to claim 8, wherein calculating the scheduling priority based on the three-stage mathematical function comprises limiting a high priority to a pre-defined ceiling.

15. The method according to claim 8, wherein calculating the scheduling priority based on the three-stage mathematical function comprises assigning a low priority to the session data packet when the packet delay is less than a pre-defined lower limit of a packet delay threshold range, assigning a high priority when the packet delay is greater than an upper limit of the packet delay threshold range, and assigning a priority according to a non-decreasing function that varies between the low and high priorities when the packet delay is within the packet delay threshold range.

16. The method of claim 8 further comprising allocating network resources used to transport the session data packets, the allocation being based on the calculated scheduling priority.

17. A system for scheduling and resource allocation in a data communication network that transports data packets for a plurality of sessions, the system comprising:
a tracking module capable of monitoring a packet delay of a session data packet awaiting transport; and
a packet scheduler capable of reevaluating a scheduling priority for the session data packet, the reevaluation being based on one or more functions of the packet delay.

18. The system according to claim 17 further comprising a resource allocation module capable of allocating network resources for transporting the data packets for the plurality of sessions.

19. The system according to claim 17 further comprising a detection module capable of identifying a service associated with the session packet.

20. The system according to claim 17 further comprising a memory for storing one or more Quality of Service (QoS) for one or more services.

21. The system according to claim 17, wherein one or more services are selected from a group comprising Voice-Over-Internet-Protocol (VoIP), video streaming, and audio streaming.
